(19) United States
(12) Patent Application Publication
(10) Pub. No.: US 2003/0231354 A1
(43) Pub. Date: Dec. 18, 2003

(54) Image input device

(76) Inventors: Shinichi Shinoda, Hitachi (JP); Keisuke Nakashima, Hitachi (JP); Takanari Tanabata, Ishioka (JP); Yoshiharu Konishi, Owariasahi (JP)

Correspondence Address: DICKSTEIN SHAPIRO MORIN & OSHINSKY LLP, 2101 L STREET NW, WASHINGTON, DC, 20037-1526, US

(21) Appl. No.: 10/270,056

(22) Filed: Oct. 15, 2002

(30) Foreign Application Priority Data
Jun. 14, 2002 (JP) 2002-173558

(51) Int. Cl. H04N 1/04; H04N 1/387; H04N 1/40; H04N 1/21

(52) U.S. Cl. 358/474; 358/444; 358/486; 358/450; 358/453

(57) ABSTRACT

An image input device comprises: a pixel shifting optical means that allows displacing an image-forming position on the image-pickup device of the incident light from the image-pickup optical system within one pixel to several pixels horizontally and vertically; an image pickup control means that controls pixel displacement conditions of the pixel shifting optical means; a resolution detection means that detects a resolution of an image on the basis of image information read by varying the pixel displacement conditions of the pixel shifting optical means; and a storage means that stores pixel information detected based on that the resolution is higher than a predetermined value, and/or information corresponding to a pixel position detected based on that the resolution is higher than the predetermined value.

### BACKGROUND OF THE INVENTION

The present invention relates to an image input device capable of processing images inputted.

In recent years, a lot of efforts have been poured into achieving an image reading with a higher resolution on the side of an image input device, and the data size of images handled has increased. The image data taken in from a digital camera and a flat bed scanner of an image input device is taken in by a PC, etc., through the USB or the parallel port, where the data is processed for use. A color image of A4 size with the resolution of 200dpi will take about 12 Mbytes for the image data. When the USB 1.1 or the Bluetooth interface of narrow band transfers the image data of 12 Mbytes, it will take some ten seconds. There are wider band interfaces available, but they are expensive, and they cannot easily be connected to a note-type PC, etc. The technique for reading images with a higher resolution has been progressing, and in the future, a higher-speed transfer of images as well as a higher-speed reading of images will become an important problem to be solved.

Here, a reading system with a high-resolution will be mentioned in brief.

A reading system that moves one-dimensional line sensor allows a high-resolution reading. However, the system reads images, while keeping exposure time, and moving the optical system with as high accuracy as 2000 line (A4, 200dpi); accordingly, it has limitations in a higher-speed reading.

On the other hand, a two-dimensional area sensor does not need to move the optical system. However, the level of the resolution does not reach A4, 200dpi. And, the one with a higher resolution will be expensive.

There are some other methods of: using plural two-dimensional area sensors with a low resolution, reading images in parallel, and synthesizing them to enhance the resolution; reading images plural times and synthesizing, while moving the reading position of one area sensor over some hundred pixels; and reading images plural times and synthesizing, while varying panning, tilting, and zooming. However, any of them involve a problem that the reading optical system becomes bigger to that extend.

As a method in which the optical system can be made up smaller than these methods, there is a method known as ‘pixel shifting’, which is disclosed in Japanese Patent Laid-open No. 2000-244932. This method uses a camera that can shift an image-forming position on an image-pickup device of an incident light from the image-pickup optical system within one pixel horizontally and vertically, executes the reading plural times while shifting the image-forming position within one pixel, synthesizes the plural image data, and obtains one sheet of images with a high resolution. This method is capable of achieving a higher resolution of the obtained images without increasing the number of pixels of the CCD.

Although this image pickup camera realizes a higher resolution, it requires the reading of plural images, which does not contribute to a higher speed.

Now, suppose that attention is attracted on a document to be read. Some one needs a high resolution, but some others do not need it and can accept a low resolution without a problem. Depending on the document, a conceivable method determines whether the document needs a high resolution or not, and if not, reads it with a low resolution to transfer. The method proposed in Japanese Patent Laid-open No. Hei 9-9044 first pre-scans a document with a high resolution, determines a resolution required for the reading, and if it does not need a high resolution, reads it with a low resolution, and thereby reduces the quantity of image data to be transferred.

### SUMMARY OF THE INVENTION

The method disclosed in Japanese Patent Laid-open No. Hei 9-9044 needs the reading with a high resolution before reading, as mentioned above, which takes more time for the reading of images. The method executes the reading of one sheet of a document with a uniform resolution only. Therefore, if the document contains a slight part of image with a high resolution, it is safer to read the image with a high resolution. Otherwise, if the information that a user needs is present in an area of the high resolution, the reading has to be executed repeatedly. In such a case, the document to be transferred with a low resolution is reduced in terms of probability, which diminishes the effect.

Therefore, an object of the invention is to provide an image input device that executes a determination of resolution in an image having a low resolution, enables a reading with an optimum resolution, and reduces the reading time.

According to one aspect of the invention, the image input device is provided with an image pickup unit that guides an incident light onto an image-pickup optical system to an image pickup device of a single plate color made up with plural pixels being arranged two-dimensionally, and creates an image signal by the image pickup device applying a photoelectric transformation to the incident light. And in addition, the image input device includes: a pixel shifting optical means that allows displacing an image-forming position on the image-pickup device of the incident light from the image-pickup optical system within one pixel to several pixels horizontally and vertically; an image pickup control means that controls pixel displacement conditions of the pixel shifting optical means; a resolution detection means that detects a resolution of an image on the basis of image information read by varying the pixel displacement conditions of the pixel shifting optical means; and a storage means that stores pixel information detected based on that the resolution is higher than a predetermined value, and/or information corresponding to a pixel position detected based on that the resolution is higher than the predetermined value.

Further, the pixel displacement conditions of the pixel shifting optical means of the image pickup control means are determined by the resolution detected by the resolution detection means.

Further, the image input device includes a transfer means that transfers pixel information detected based on that the resolution is higher than the predetermined value, and/or information corresponding to a pixel position detected based on that the resolution is higher than the predetermined value.

Further, the image input device includes: a first storage means that stores the image information by the storage control means; a transfer means that transfers the image information stored; a second storage means that stores the image information transferred; and a means that executes a rearrangement of pixels and/or an interpolation of pixels, on the basis of the pixel information stored in the second storage means and the pixel displacement conditions.

### BRIEF DESCRIPTION OF THE DRAWINGS

Other objects and advantages of the invention will become apparent from the following description of embodiments with reference to the accompanying drawings in which:

FIG. 1 illustrates one embodiment of an image input device according to the present invention;

FIG. 2 illustrates one embodiment of a resolution determination unit of the image input device according to the present invention;

FIG. 3 is a diagram in assistance for explaining the resolution determination in the image input device according to the present invention;

FIG. 4 illustrates one embodiment of an image pickup control for the resolution determination in the image input device according to the present invention;

FIG. 5 illustrates one embodiment of a selective transfer unit of the image input device according to the present invention;

FIGS. 6A through 6I are diagrams in assistance for explaining the rearrangement of pixels in the image input device according to the present invention;

FIG. 7 illustrates another embodiment of the resolution determination unit of the image input device according to the present invention;

FIG. 8 is a diagram in assistance for explaining the resolution determination in the image input device according to the present invention;

FIG. 9 illustrates another embodiment of the image input device according to the present invention;

FIG. 10 illustrates a memory map of reference pixels for an interpolation processing in the image input device according to the present invention;

FIG. 11 illustrates a memory map of reference pixels for the interpolation processing in the image input device according to the present invention;

FIG. 12 illustrates another embodiment of the image input device relating to the present invention; and

FIG. 13 illustrates another embodiment of the image input device according to the present invention.

### DESCRIPTION OF THE PREFERRED EMBODIMENTS

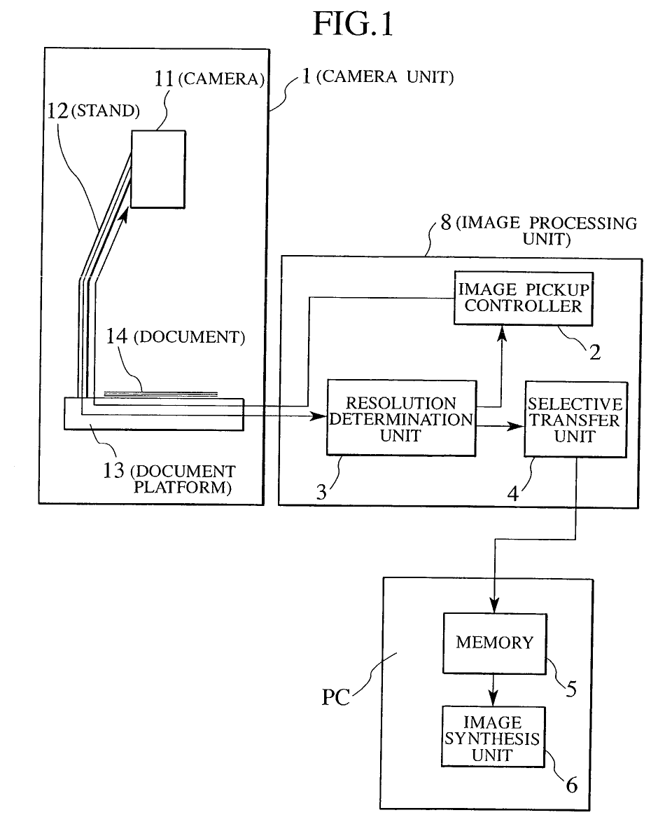

An embodiment of the invention will be described with reference to FIG. 1.

FIG. 1 illustrates a device configuration of the embodiment. The image input device of this embodiment includes a camera unit 1 made up with a document platform 13, a stand 12, and a camera head 11 that reads a document 14 on the document platform 13, etc., and an image processing unit 8 that executes an image processing to images read by the camera unit 1.

The camera head 11 in this embodiment uses a two-dimensional image pickup device, on which a CCD area sensor being an image pickup device of a single plate color is mounted. It is an image pickup camera for an image pickup unit provided with a pixel shifting optical unit that can shift an image-forming position on the image-pickup device of an incident light from the image-pickup optical system within one pixel to several pixels horizontally and vertically. This image pickup unit guides the incident light on the image-pickup optical system to the image pickup device of a single plate color made up with plural pixels arranged two-dimensionally. The image pickup device applies a photoelectric transformation to the incident light into an image signal.

In regard to one sheet of document placed on the document platform 13, the camera head 11 supported by the stand 12 over the document platform 13 is able to obtain image data for three sheets at image-forming positions that are shifted by 0 pixel, ⅓ pixel (⅓ pixel shifting, once), and ⅔ pixel (⅓ pixel shifting, twice), horizontally in unit of ⅓ pixel. In the same manner, the camera is able to obtain image data for three sheets while shifting the image-forming positions vertically by 0 pixel, ⅓ pixel, and ⅔ pixel. Therefore, nine sheets of image data in total can be acquired. The image data acquired are transferred to the image processing unit 8.

The image processing unit 8 is composed of a resolution determination unit 3 that determines a resolution of an image from image information read by the camera unit 1, an image pickup controller 2 that sets and controls the pixel displacement conditions of the pixel shifting optical unit such as a displacement (normally, ⅓ pixel) and a frequency of reading (normally, 9 times), etc., on the basis of a determined resolution, and a selective transfer unit 4 that selectively transfers only a part whose resolution is determined as high by the resolution determination unit 3. The image data transferred are stored in a memory 5. On the basis of the image data stored, an image synthesis unit 6 synthesizes the image data into one sheet of high-resolution image data.

The image pickup controller 2 and the control of the image pickup camera are described in detail in Japanese Patent Laid-open No. 2000-244932, and the explanations about these subjects will be omitted here. And, in Japanese Patent Laid-open No. 2000-244932, the image-forming position is shifted by ½ pixel, however ⅓ pixel shifting can be considered in the same manner.

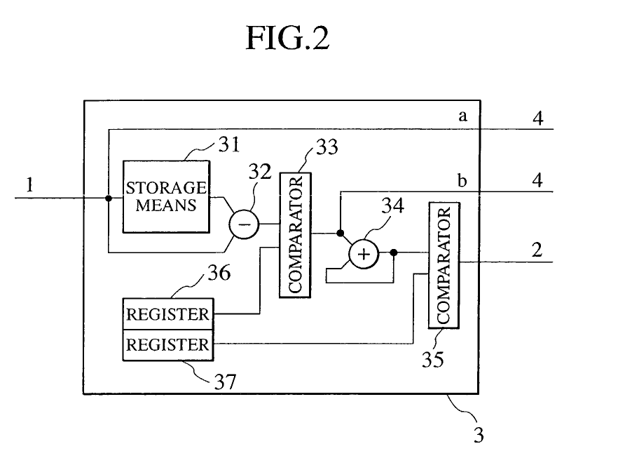

Next, the resolution determination unit 3 will be described with reference to FIG. 2, which varies the pixel displacement conditions of the pixel shifting optical unit, and determines a resolution of an image to be read on the basis of image information having been read.

The image data read by the camera unit 1 is dividedly transferred to a route trough which the image data is outputted to the selective transfer unit 4 as it remains intact as an image data a, to a route through which the image data is stored in a storage means 31, and to a route through which the image data is inputted to a subtracter 32 to calculate a difference from the previous image data. In this embodiment, assuming that the image data read by the camera unit 1 is an image data after the image-forming position was shifted by ⅓ pixel, the image data stored in the storage means 31 is an image data before it was shifted by ⅓ pixel.

The subtracter 32 calculates a difference by each pixel, in regard to two sheets of image data consisting of the image data before shifting and the image data after shifting. A comparator 33 compares a difference value with a specific value stored in a register 36. If the difference value is more than the specific value, for example, the comparator outputs “1”, and if it is less than the specific value, the comparator outputs “0” to the selective transfer unit 4 as a signal b. The specific value may be set in advance, or it may be designed that a user can set the value at any time from the outside.

An adder 34 adds the number of pixels of the output (the difference being more than the specific value) from the comparator 33. If the total value of the adder 34 is lower than a specific value stored in a register 37, a comparator 35 judges that the resolution of the whole document is low, and outputs the pixel displacement condition corresponding to one with a low resolution and/or the frequency of reading, etc., to the image pickup controller 2.

In this case, the comparator 35 compares the total value. However, it is conceivable to store the pixel displacement condition and/or the frequency of reading in a table in advance, and acquire the pixel displacement condition and/or the frequency of reading, by means of a translation table on the basis of the total value.

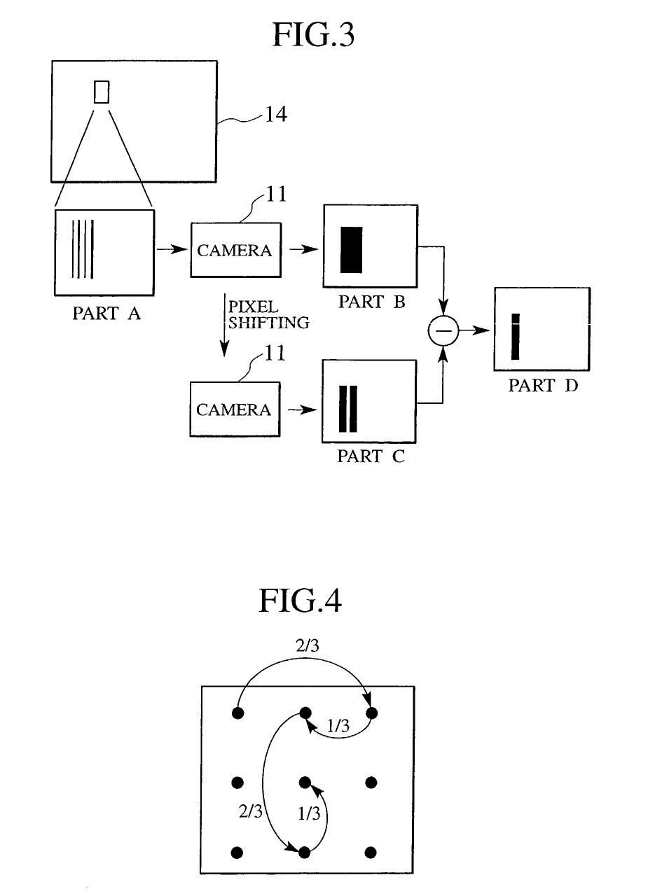

Then how to determine the resolution will be described with reference to FIG. 3. Suppose that a certain part of the document 14 being expanded to be brought into sight is a pattern having thin lines arrayed vertically as a part A. If this part is read with a low resolution, the thin lines will not be resolved, and they will be read in a black lump as a part B.

If this is read by means of a pixel shifting, it will acquire an image as a part C. Although the resolution is not comparable to the part B, but it is clearly different form the part B. The difference of the part B and the part C is created by a reading in which the image-forming position is shifted by, for example, ⅔ pixel. One sheet of the image with a low resolution does not show the edges of the thin lines in the part A, however a use of the difference image will reveal more edges. And, it can be considered that as an area has more parts in which the difference between the part A and part B is large, the resolution in that area is higher. That is, with regard to tow sheets of image data, the image data before displacing the image-forming position on the image pickup device by the pixel shifting, and the image data after displacing the image-forming position, it is considered that to calculate the number of pixels in which the difference is large permits to determine the resolution to be high or low. In this case, though the determination of the resolution being high or low is based on the difference between two sheets of images, it is also conceivable that repeating the determination processing in the same manner after changing the displacement will attain an optimum resolution. The displacement to an optimum image-forming position is considered to be the displacement to the image-forming position that contains a large number of pixels in which the difference is large. If there is not a big change in the number of pixels in which the difference is large, it is conceivable to change the displacement into a bigger one. The displacement is something like a notch value. In this case, the maximum displacement is less than one pixel. If the displacement is bigger, the frequency of reading becomes lower; If the displacement is smaller, the frequency of reading becomes higher.

The number of pixels in which the created difference is large is also related to the displacement to the image-forming position and the resolution of a document. In order to acquire an optimum resolution by repeating the determination processing, it is conceivable to greatly displace the image-forming position, and then displace it little, as shown in FIG. 4. For example, first the image-forming position on the upper left is displaced by ⅔ pixel in the main scanning (horizontal) direction, and thereafter, it is displaced by ⅓ pixel, thus obtaining an optimum displacement to the image-forming position in the main scanning (horizontal) direction. In the vertical (sub scanning) direction, the same processing is made to obtain an optimum displacement to the image-forming position.

In reverse to that, it is also considered to displace the image-forming position little at first, and thereafter displace it greatly.

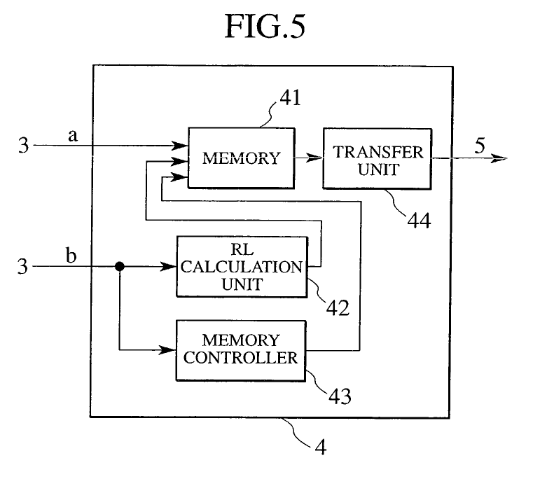

Next, the selective transfer unit 4 will be described with reference to FIG. 5. In regard to the image data a from the resolution determination unit 3, only the pixels in which the difference signal b is “1” (the difference is large) are controlled by a memory controller 43 to be stored in a memory 41. The difference signal b is also stored as a run length value in the memory 41 through an RL calculation unit 42. The image data a and the run length value of the difference signal b stored in the memory 41 are transferred from the transfer unit 44 to the outside of the image processing unit 8.

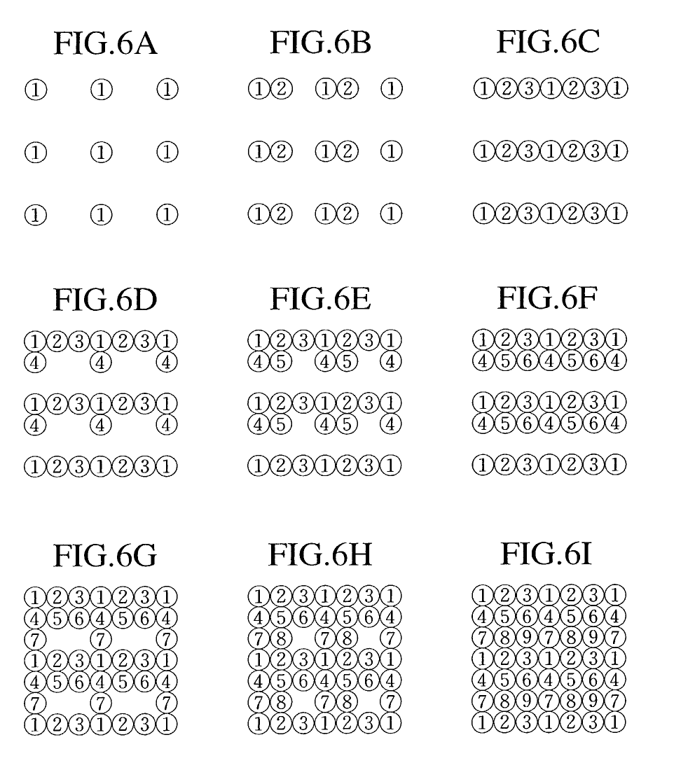

And, returning to FIG. 1, the image data a and the run length value of the difference signal b thus transferred are stored in the memory 5. The image synthesis unit 6 creates a high-resolution image based on the image data stored in the memory 5. For example, when nine sheets of images of three sheets by the vertical shifting and three sheets by the horizontal shifting are synthesized into one sheet, the arrangement of pixels inside the memory 5 becomes as shown in FIG. 6.

FIG. 6A through FIG. 6I illustrates the pixel arrangements inside the memory 5 after reading the images of the first sheet through the ninth sheet. In the horizontal direction are arranged pixel \mathring{1} of the first sheet, next, pixel \mathring{2} of the second sheet, and next, pixel \mathring{3} of the third sheet. Below the first row are arranged pixel \mathring{4} of the fourth sheet just beneath pixel \mathring{1}, pixel \mathring{5} of the fifth sheet next on the right, and pixel \mathring{6} of the sixth sheet. In the same manner, below the second row are arranged pixel \mathring{7} of the seventh sheet just beneath pixel \mathring{4}, pixel \mathring{8} of the eighth sheet next on the right, and pixel \mathring{9} of the ninth sheet. In this manner, the images of the first sheet through the ninth sheet are rearranged by pixels.

In the method proposed in this invention, the images of the first sheet are developed, and those of the second sheet and after are arranged with the image data of the pixels in which the difference between images is large, and the run length value of the difference signal corresponding to the pixel position.

Since the difference signal “1” means a pixel in which the difference is large, the image data for the number of “1” are stored. The data are needed to be set in and rearranged sequentially at the pixel positions of “1”. When the rearrangement of the image data transferred is completed, there remain the image data at the positions of the pixels in which the difference between images is small, namely the image data at the pixel positions of the difference signal “0”. It can be considered that, for example, the image data at the same pixel positions on the first sheet are substituted for those thereat without any problems. Further, with reference to the surrounding pixels, the average of these may be employed. The image data placed at the pixel positions of the difference signal “0” need not be created last, and they may be created when the images of the first sheet are developed, or on the way of the development of the first sheet and after.

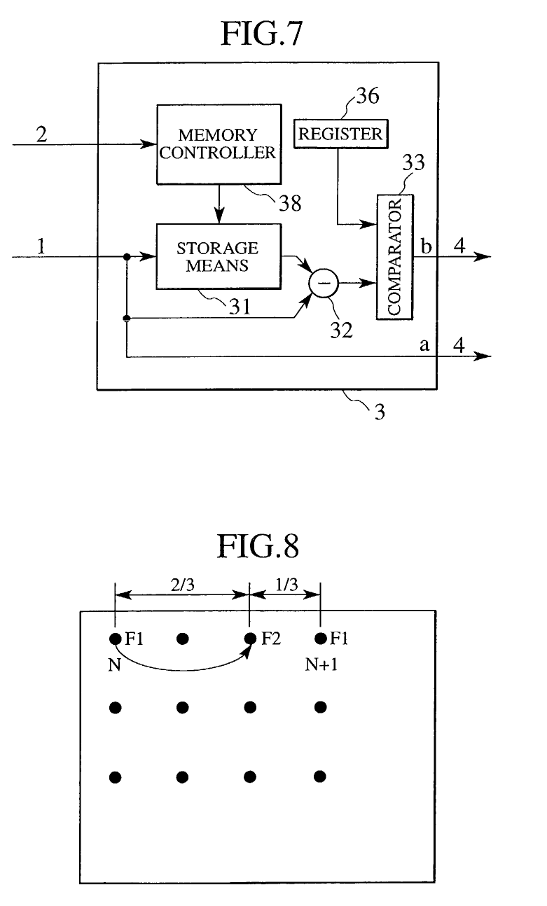

Next, another embodiment of the resolution determination unit 3 illustrate in FIG. 7 will be described.

The storage means 31 stores the image data of the first sheet, and the subtracter 32 always calculates the difference values between the image data inputted after the first sheet and the image data of the first sheet. The comparator 33 compares the difference value acquired by the subtracter 32 with a specific value stored in the register 36, and outputs the result to the selective transfer unit 4. A memory controller 38 designates the pixel position on the first sheet to be compared. Here, it is conceivable that the image pickup controller 2 designates the pixel position on the first sheet to be compared, on the basis of a signal corresponding to how far the image-forming position of the image data now being read is displaced from the corresponding position on the first sheet.

Suppose that, as shown in FIG. 8, the pixel positions corresponding to the N-th pixel and (N+1)-th pixel of the first sheet image data F1 are arranged, and the image data read by displacing by ⅔ pixel by the pixel shifting is given by the N-th pixel of the second sheet image data F2. In this case, the N-th pixel of F2 is dislocated by ⅔ pixel from the N-th pixel of F1, but it is dislocated only by ⅓ pixel from the (N+1)-th pixel of F1. Accordingly, the N-th pixel of F2 can be considered to show a closer value to the (N+1)-th pixel of F1. Therefore, in acquiring the difference, calculating the difference between the N-th pixel of F2 and the (N+1)-th pixel of F1 will further reduce the difference than calculating the difference between the N-th pixel of F2 and the N-th pixel of F1; and the number of pixels to be transferred in which the difference is large becomes decreased.

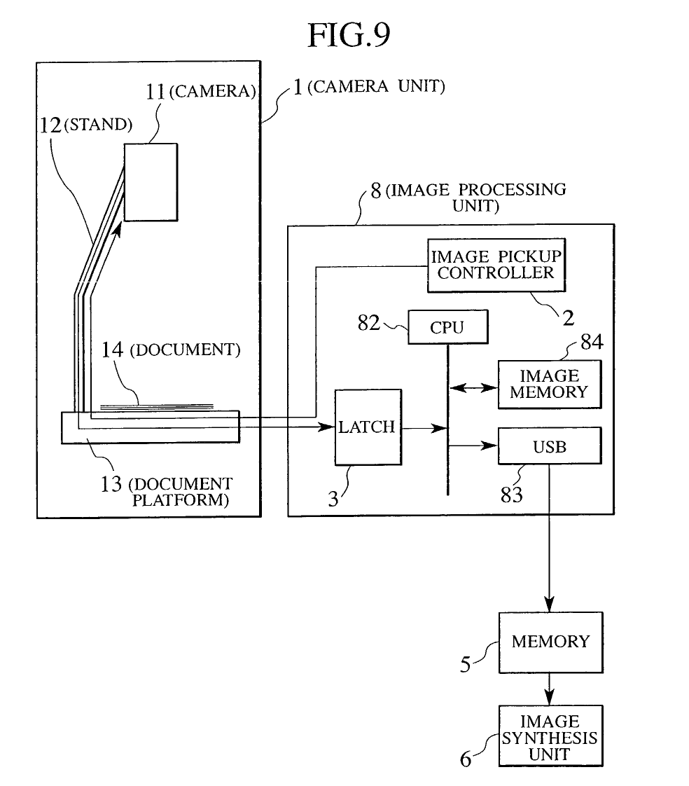

Next, one embodiment of the invention will be described with FIG. 9. In this embodiment, nine sheets of images read by the pixel shifting are synthesized into one sheet of images with a high resolution. The image data read by the camera unit 1 are latched by a latch 81, first, and are being stored in an image memory 84. The nine sheets of image data stored in the image memory 84 are transferred to a PC or the like through a communication unit. In this embodiment, the communication unit employs the USB 83, however it is not limited to this, and it may use the IEEE1394 or the like. Or, the image data may be transmitted through the radio.

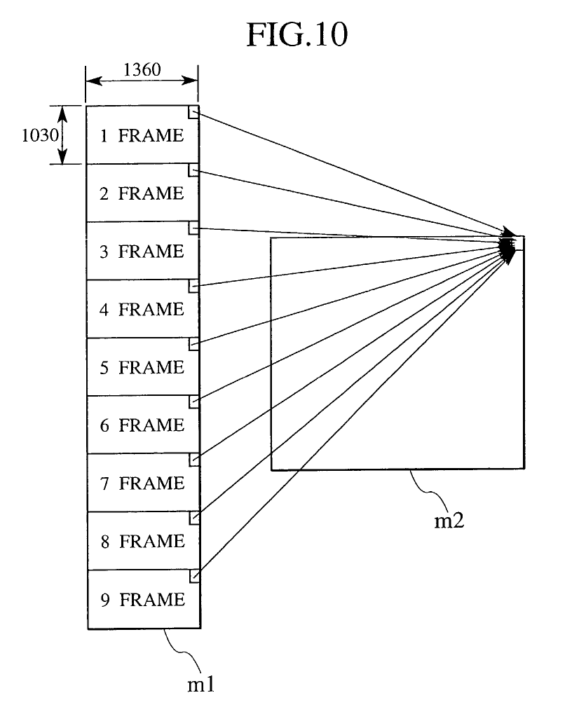

The image data transferred are stored in the memory 5, which are synthesized by the image synthesis unit 6. The reading by the pixel shifting inevitably needs a rearrangement by each pixel of the frame. Here, in order to execute an interpolation processing together, it is needed to create interpolation pixels by referring to the surrounding pixels. In such a case, a remote place on the memory is to be referred to, as shown in FIG. 10. This case requires an area of 1360×1030 bytes per sheet, and the image data are referred to at nine memory addresses separated each 1360×1030 bytes. Accordingly, there is a possibility that the miss hits of the cache in the CPU 82 increase to take more processing time.

Provided that the CPU 82 in the image processing unit 8 is high-speed and the bus throughput is high, when the image data are stored in the image memory 84, if the image data are written each one pixel (one byte) so as to be in time for the timing of data reading, there will not be any problem. In the writing, the image data are written each one pixel with a space of the number of frames left, in consideration of being arranged vertically and horizontally; and the data are being written in a space of the next frame with the same space left. Thus, at the time the reading of the nine sheets is completed, the rearrangement of the pixels is also completed.

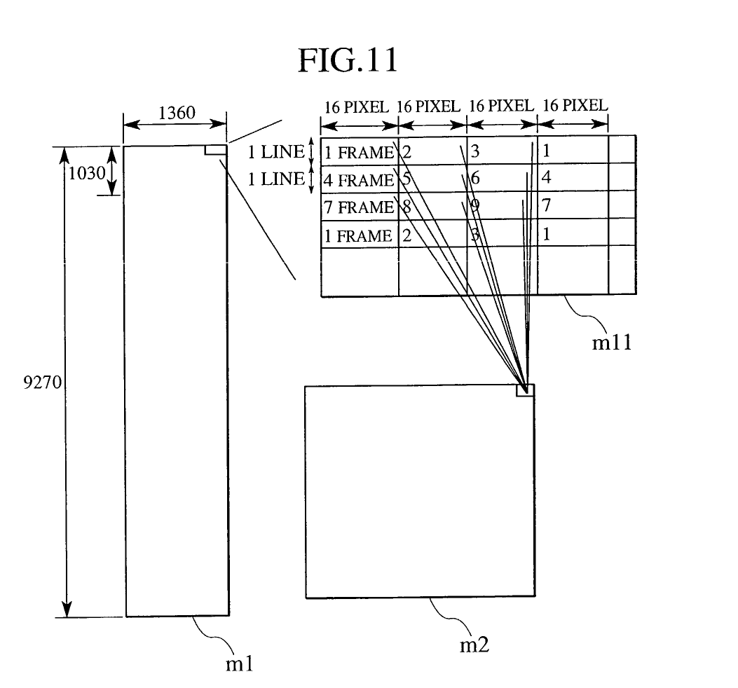

However, a high-speed CPU or a CPU with a high bus throughput will be expensive. Accordingly, FIG. 11 illustrates a method that executes a simple rearrangement by using an inexpensive CPU to reduce the cache miss hits in the CPU on the PC side.

In this case, 16 pixels are treated as one block for arrangement. Accordingly, the writing processing needs to be executed each 16 pixels. Therefore, the writing of 16 pixel continuous data each 16 pixels can save time, compared with the writing each one pixel. The expansion of m1 transferred to the PC side is m11. In making an interpolation, if the surrounding 9 pixels are referred to, a range of 48 pixels×3 lines is needed to be watched. Thereby, the cache miss hits of the CPU can be reduced. In the simulation of the interpolation processing, the addresses used for referring to the memory on the PC side were compared with the case of FIG. 10 and the case of FIG. 11. The result showed that the method of FIG. 11 reduced the processing time to ⅓ of the method of FIG. 10. In the same manner, in the simulation of the interpolation processing, a case in which the rearrangement is made each one pixel and a case of FIG. 11 in which the rearrangement is made each 16 pixels were compared. The result showed that the processing times were comparable.

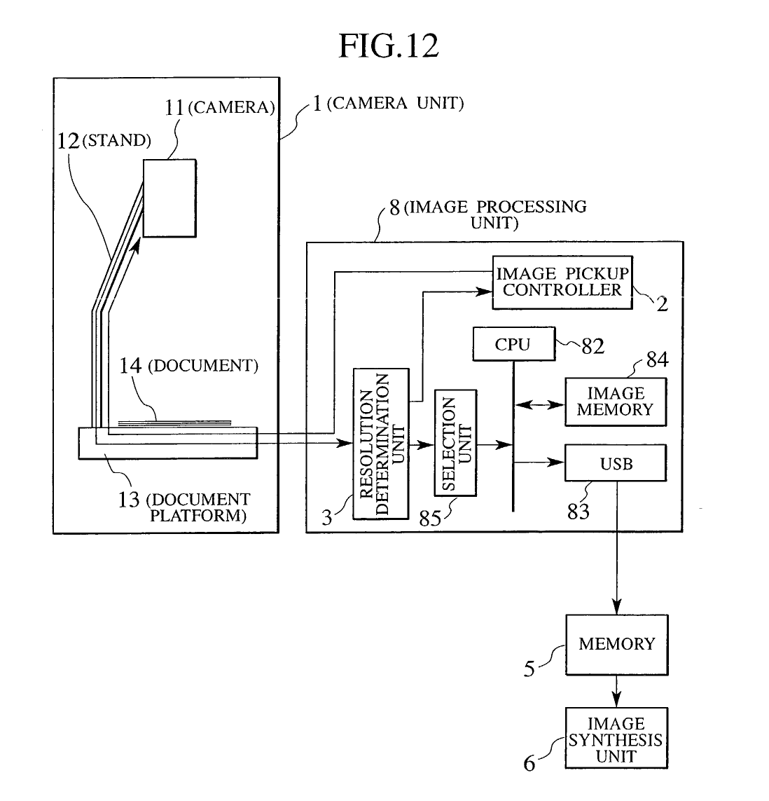

FIG. 12 illustrates another embodiment of the invention, in which the resolution determination and the selective transfer and the previous simplified rearrangement are combined.

The resolution determination unit 3 executes the processing each one pixel, however it may execute the processing in unit of block.

For example, a simplified rearrangement may be carried out based on the size of a divided block. In this case, as to whether the pixel area of the block is an area with a high resolution or not, the difference values from the previous images as to the pixels inside the block are calculated; and when there are pixels in which the differences are large, or when there are many, the block is considered to have a high resolution. The image memory 84 stores the image data of the first sheet, the image data inside the block in which the differences of the first sheet and after are large (the resolution is high), and the position information of the block. The image memory 84 does not store the image information of a block of pixels in which the differences are small. In the writing, since the image information of a block of pixels in which the differences are small are not stored, they are closely written. In that case, since the simplified rearrangement is made, after one block is written, the writing is made with a space of the blocks corresponding to the number of the frames to be read.

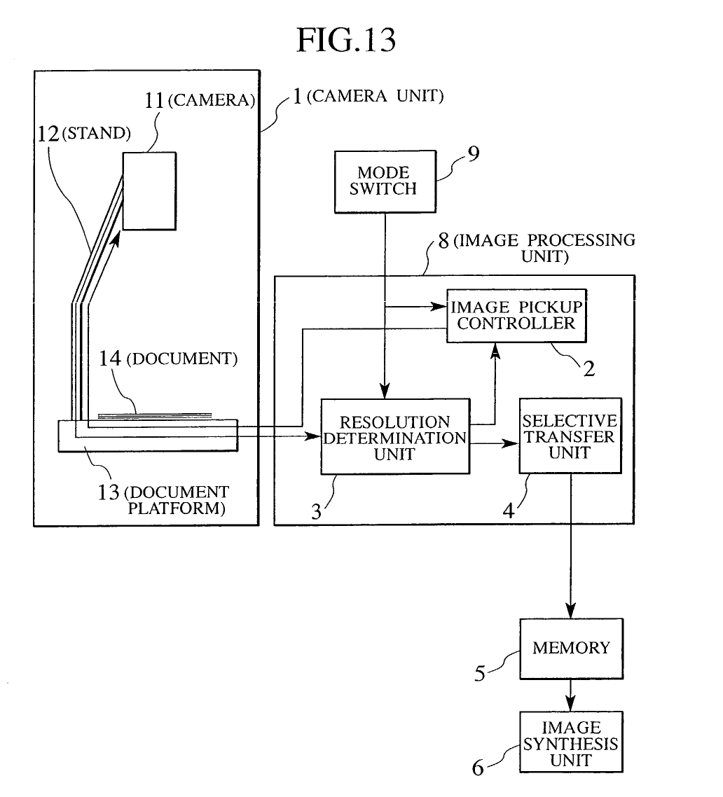

When the reading is desired to halt after finishing the resolution determination, as shown in FIG. 13, it is conceivable to provide a mode switch 9 that automatically determines a resolution and reads an optimum resolution. When the mode switch 9 comes to “1”, the register to compare the difference values in the resolution determination unit 3 is set to “0”. Accordingly, large signals do not enter, all become the parts with a high resolution, and the pixel displacement condition and the reading frequency and/or the transfer become correspondent to the high resolution. It may be made that whether the current mode is the mode for reading with the optimum resolution or not is informed to a user. For example, the mode may be informed to a user by a light by providing the mode switch 9 with an LED, or the mode may be displayed by providing a display unit such as a display or a monitor.

According to the invention, the resolution determination can be performed to images with a low resolution, the reading is possible in an optimum resolution, and the reading time can be shortened.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. An image input device having an image pickup unit that guides an incident light onto an image-pickup optical system to an image pickup device of a single plate color made up with plural pixels being arranged two-dimensionally, and creates an image signal by the image pickup device applying a photoelectric transformation to the incident light, the image input device comprising:
a pixel shifting optical means that allows displacing an image-forming position on the image-pickup device of the incident light from the image-pickup optical system within one pixel to several pixels horizontally and vertically;
an image pickup control means that controls pixel displacement conditions of the pixel shifting optical means;
a resolution detection means that detects a resolution of an image on the basis of image information read by varying the pixel displacement conditions of the pixel shifting optical means; and
a storage means that stores pixel information detected based on that the resolution is higher than a predetermined value, and/or information corresponding to a pixel position detected based on that the resolution is higher than the predetermined value.

2. An image input device having an image pickup unit that guides an incident light onto an image-pickup optical system to an image pickup device of a single plate color made up with plural pixels being arranged two-dimensionally, and creates an image signal by the image pickup device applying a photoelectric transformation to the incident light, the image input device comprising:
a pixel shifting optical means that allows displacing an image-forming position on the image-pickup device of the incident light from the image-pickup optical system within one pixel to several pixels horizontally and vertically;
an image pickup control means that controls pixel displacement conditions of the pixel shifting optical means; and
a resolution detection means that detects a resolution of an image to be read, on the basis of image information read by varying the pixel displacement conditions of the pixel shifting optical means, wherein:
the pixel displacement conditions of the pixel shifting optical means of the image pickup control means are determined by the resolution detected by the resolution detection means.

3. An image input device as claimed in claim 2, wherein:
the pixel displacement conditions of the pixel shifting optical means of the image pickup control means, which are determined by the resolution detected by the resolution detection means, are displacement quantities of pixels to be read, and/or reading frequencies read by displacing pixels.

4. An image input device as claimed in at least one of claim 1 through claim 3, wherein:
the resolution detection means uses the pixel displacement conditions of the pixel shifting optical means, the image information read before changing into the pixel displacement conditions, and the image information read after changing into the pixel displacement conditions.

5. An image input device as claimed in at least one of claim 1 through claim 4, wherein:
the pixel displacement conditions of the pixel shifting optical means first take a large pixel displacement, and then take a small pixel displacement.

6. An image input device as claimed in claim 1, comprising:
a transfer means that transfers pixel information detected based on that the resolution is higher than the predetermined value, and/or information corresponding to a pixel position detected based on that the resolution is higher than the predetermined value.

7. An image input device as claimed in claim 1, wherein:
the resolution detection means detects the resolution as high, when the difference information of the image information read before changing into the pixel displacement conditions and the image information read after changing into the pixel displacement conditions is larger than a predetermined value.

8. An image input device as claimed in claim 7, wherein:
the resolution detection means detects the resolution as high, when the difference information between frames of the image information read before changing into the pixel displacement conditions and the image information read after changing into the pixel displacement conditions is larger than a predetermined value.

9. An image input device as claimed in claim 8, wherein:
when changing into the pixel displacement conditions to read, and calculating the difference information between frames, the resolution detection means changes the pixel position where the differences are calculated based on the pixel displacement quantities.

10. An image input device as claimed in claim 1, wherein:
the image pickup control means determines the pixel displacement conditions of the pixel shifting optical means based on the resolution detected by the resolution detection means.

11. An image input device having an image pickup unit that guides an incident light onto an image-pickup optical system to an image pickup device of a single plate color made up with plural pixels being arranged two-dimensionally, and creates an image signal by the image pickup device applying a photoelectric transformation to the incident light, the image input device comprising:
a pixel shifting optical means that allows displacing an image-forming position on the image-pickup device of the incident light from the image-pickup optical system within one pixel to several pixels horizontally and vertically;
an image pickup control means that controls pixel displacement conditions of the pixel shifting optical means;
a storage control means that partitions image information read by changing the pixel displacement conditions of the pixel shifting optical means into blocks of a specific size, and stores with a space left corresponding to the pixel displacement conditions;
a first storage means that stores the image information by the storage control means;
a transfer means that transfers the image information stored;
a second storage means that stores the image information transferred; and
a means that executes a rearrangement of pixels and/or an interpolation of pixels, on the basis of the pixel information stored in the second storage means and the pixel displacement conditions.

12. An image input device as claimed in claim 11, wherein:
only in case of a block having a resolution in which the resolution detected by the resolution detection means is higher than the predetermined value, the storage control means stores the block with a space left corresponding to the pixel displacement conditions.

13. An image input device as claimed in claim 11, wherein:
the storage control means determines the pixel displacement conditions of the image pickup control means based on the resolution detected by the resolution detection means, partitions image information read by changing the pixel displacement conditions of the pixel shifting optical means into blocks of a specific size, and stores the pixel information detected based on that the resolution detection means detected the resolution to be higher than a predetermined value, with a space left corresponding to the pixel displacement conditions.

14. An image input device as claimed in at least one of claim 1, comprising a switch of a mode that automatically determines the resolution and reads with an optimum resolution.

15. An image input device as claimed in claim 14, comprising a means that informs a user of a state as to whether or not it is a mode that reads with the optimum resolution.
